(19) United States
(12) Patent Application Publication
(10) Pub. No.: US 2008/0222232 A1
(43) Pub. Date: Sep. 11, 2008

(54) Method and Apparatus for Widget and Widget-Container Platform Adaptation and Distribution

(76) Inventors: Stewart O. Allen, Reston, VA (US); Scott F. Cosby, Rye, NY (US); Hasseltine R. Debutts, Upperville, VA (US); John A. Fath, Arlington, VA (US); Hooman Radfar, Arlington, VA (US); Carlos F. Reverte, Miami, FL (US)

Correspondence Address: COOLEY GODWARD KRONISH LLP;ATTN: PATENT GROUP, Suite 1100, 777 - 6th Street, NW, WASHINGTON, DC, 20001, US

(21) Appl. No.: 11/682,626

(22) Filed: Mar. 6, 2007

(51) Int. Cl. G06F 15/16

(52) U.S. Cl. 709/201

(57) ABSTRACT

A method includes receiving a request for a widget-container defined in response to a reference to the widget-container being accessed from a content aggregation point. The widget-container is a procedural software framework configured to be executed within the content aggregation point. The widget-container has a portion configured for receiving a widget. The method includes modifying a portion of the widget-container. The portion of the widget-container is based on a first configuration before the modifying and based on a second configuration substantially compliant with a content rule associated with the content aggregation point after the modifying.

### BACKGROUND

The disclosed invention relates generally to interoperability of content with content aggregation points, and in particular, to modification of content and/or data associated with the content for compatibility with content aggregation points.

The world wide web is a platform that has been used to exchange various forms of content including videos, text, music, etc. Often this content is distributed to users and/or computers in an ad-hoc fashion, for example, using e-mail or as files embedded in a web-page. Recently, various forms of “viral” distribution or replication of content have been developed that allow users to more easily spread content to other users than previously known ad-hoc methods. Although these viral distribution methods are more convenient than distributing content in an ad-hoc fashion, they have many shortcomings. For example, they do not provide for methods for automated distribution of virally distributed content into aggregation points (e.g., web sites, galleries, directories, etc.) that may have different ways of representing data associated with the content. Often a user may not be allowed to place content into an aggregation point when the content and/or data associated with the content is not compliant with a format specific to the aggregation point. Thus, there is a need for an apparatus and method for translation of content or data associated with the content for compatibility with content aggregation points.

### SUMMARY OF THE INVENTION

A method includes receiving a request for a widget-container defined in response to a reference to the widget-container being accessed from a content aggregation point. The widget-container is a procedural software framework configured to be executed within the content aggregation point. The widget-container has a portion configured for receiving a widget. The method includes modifying a portion of the widget-container. The portion of the widget-container is based on a first configuration before the modifying and based on a second configuration substantially compliant with a content rule associated with the content aggregation point after the modifying.

### BRIEF DESCRIPTION OF THE DRAWINGS

The present invention is described with reference to the accompanying drawings. In the drawings, identical or like reference numbers indicate identical or functionally similar elements.

FIG. 1 is a schematic block diagram that illustrates a widget-container host configured to modify at least a portion of a widget-container using a transform module based on one or more content rules associated with one or more content aggregation points, according to an embodiment of the invention.

FIG. 2 illustrates a widget-container host and a widget server configured to serve a widget-container and a widget, respectively, to a content aggregation point, according to an embodiment of the invention.

FIG. 3 is a flowchart that illustrates a method for modifying a portion associated with a widget-container based on a content rule associated with a content aggregation point, according to an embodiment of the invention.

FIG. 4 illustrates a widget server configured to send a widget and/or a widget-container to a widget-container host to be modified at the widget-container host before being sent to a content aggregation point, according to an embodiment of the invention.

FIG. 5 illustrates an example of a table that can be used to select a transform module to modify a portion of a widget-container for processing at a content aggregation point, according to an embodiment of the invention.

FIG. 6 illustrates a widget-container host configured to produce instances of a master copy of a widget-container and/or a master copy of a widget using a transform module, according to an embodiment of the invention.

FIG. 7 is a flow chart that illustrates a method for placing a reference to a widget-container in a content aggregation point, according to an embodiment of the invention.

### DETAILED DESCRIPTION

A widget-container (also can be referred to as a container) is a procedural software framework that can be configured to contain a widget and/or contain at least one service module that can be associated with the widget and/or widget-container. As a procedural software framework, the widget-container can be a series of instructions that are executable (e.g., interpretable) by, for example, a processor of, for example, a computer or mobile phone. The widget and/or service module is “contained” in the widget-container when a widget and/or service module is either referenced in a widget-container or actually integrated into the procedural software framework of the widget-container. In some embodiments, the widget-container includes a portion that is configured for processing of the widget within the widget-container. The widget and/or service module when being contained in the widget-container can be referred to as being wrapped or containerized in the widget-container. In some embodiments, the widget and/or the service module (or references to the widget and/or service module) can be referred to as components or portions of the widget-container.

The widget-container is a portable framework that can be referenced in (e.g., embedded in, referenced using an embed or object tag) and/or accessed from/using a content aggregation point. For example, when a request for the widget-container (and a widget associated with the widget-container) is received in response to a reference to the widget-container being accessed from a content aggregation point, the widget-container can be served for execution within the content aggregation point in response to the request. A content aggregation point can be, for example, a desktop, a start page, a wireless application protocol (WAP) gallery, a gallery, a portal, a processor readable-vehicle (e.g., web-page, web site), and/or a directory. WAP galleries, web galleries, and so forth are types of content aggregation points that can be referred to as content distribution points because they can be vehicles from which content such as widgets and/or widget-containers can be distributed. A content distribution point can be a type of processor-readable vehicle. More details regarding processor-readable vehicles are set forth in co-pending application Ser. No. 11/537,362, “Method and Apparatus for Widget-Container Hosting and Generation,” which is incorporated herein by reference in its entirety.

The widget can be any type of object such as a static data object (e.g., text or textual document), media object (e.g., video, MP3, or image), and/or software object (e.g., Javascript, Flash program) that can be contained (e.g., integrated or referenced) and/or processed in the widget-container. Components of the widget-container are processed within the widget-container when they are, for example, executed, rendered, manipulated, and/or displayed.

A portion associated with a widget-container (e.g., widget associated with a widget-container, service module associated with a widget-container, widget-container framework, entire widget-container containing a widget(s) and/or a service module(s)) and/or a widget (e.g., widget not associated with a widget-container) can be modified using a transform module such that the portion associated with the widget-container and/or widget is compatible with a content rule associated with a content aggregation point. The portion associated with the widget-container and/or widget can be modified by modifying a portion of code, a metadata parameter value associated with the portion and/or widget, a packaging type, and/or a format associated with the widget such that the widget can be processed at the content aggregation point. In some embodiments, a transform module can be configured to use (e.g., follow) a submission process associated with the content aggregation point. In some embodiments, a transform module can be configured to modify a widget and/or a portion associated with a widget-container for processing within a content aggregation point for different types of processing devices (e.g., mobile phone, computer).

An updated version of a content rule associated with a content aggregation point can be automatically detected and received in some embodiments. The updated content rule can be received from a content aggregation point host based on various criteria and/or indicators. The widget and/or portion associated with a widget-container can be automatically modified according to the updated content rule. In some embodiments, one or more transform modules can be automatically selected and used to modify a widget and/or a portion associated with a widget-container from a first configuration to a second configuration such that the widget and/or portion is compliant (e.g., substantially compliant) with one or more content rules associated with one or more content aggregation points. In some embodiments, modified and/or unmodified widgets and/or portions of a widget-container can be stored at and/or served from one or more devices.

Although many of the embodiments within the detailed description are described with respect to portions associated with widget-containers (e.g., widget associated with a widget-container, service module associated with a widget-container, widget-container framework, entire widget-container containing a widget(s) and/or a service module(s)) a person of skill in the art, having the benefit of this detailed description, can recognize that the methods and apparatus associated with the embodiments can be applied to widgets that are not associated with a widget-container. In some embodiments, a reference to the widget (not associated with a widget-container) can be placed in (e.g., included in) one or more content aggregation points. In some embodiments, a widget (not associated with a widget-container) can be associated with a widget-container after, for example, being modified using a transform module.

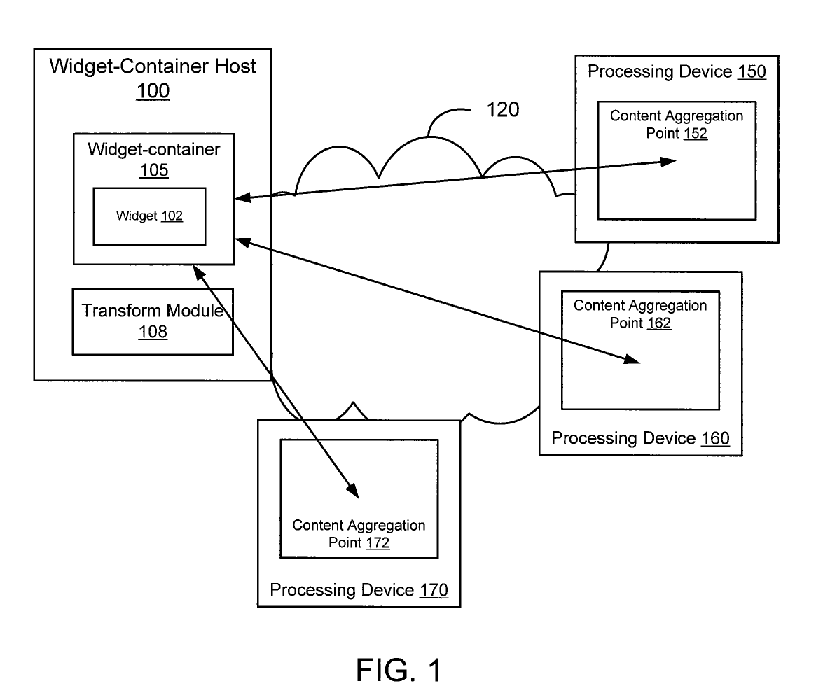

Referring now to the drawings, FIG. 1 is a schematic block diagram that illustrates a widget-container host 100 configured to modify at least a portion associated with a widget-container 105 using a transform module 108 based on one or more content rules associated with content aggregation points 152, 162, and/or 172, according to an embodiment of the invention. Modifying can include modifying data associated with the portion associated with the widget-container 105. The portion can be, for example, a widget 102 and/or a service module (not shown) associated with the widget-container 105. If the widget 102 and/or widget-container 105 satisfies the content rule(s) associated with the content aggregation points 152, 162, and/or 172, the widget-container host 100 can be configured to send (e.g., send an instance, serve an instance) over network 120 the widget 102 and/or widget-container 105 to one or more of the content aggregation points 152, 162, and/or 172. The widget 102 and/or widget-container 105 can be processed (e.g., displayed, executed) at one or more of the content aggregation points 152, 162, and/or 172.

The content aggregation points 152, 162, and/or 172 can be, for example, a desktop, a web site (e.g., processor-readable vehicle, WAP site), or a content distribution point (e.g., web-based gallery, a web-based portal). The content aggregation points 152, 162, and/or 172 can be associated with, for example, a personal computer or a mobile device such as a personal digital assistant (PDA). The widget-container 105 can be a procedural software framework that can contain (e.g., include a reference to) the widget 102. As a procedural software framework, the widget-container can be a series of instructions that are executable (or interpretable) by, for example, a processor (not shown) associated with one or more of the processing devices 150, 160, and/or 170.

The widget 102 can be, for example, a static data object, a software object, and/or a media object. For example, the widget 102 can be an executed (e.g., played) or a displayed media object such as a video file (i.e., a video content file), an MP3 file (i.e., audio content file), or an image file (i.e., image content file). The widget 102 can be a static data object that is, for example, displayed within the widget-container 105. The static data object can be, for example, a textual object such as a set of letters, a textual document, or an html based textual document. The static data object can include, for example, links to other widgets (not shown). The widget 102 can also be a software object such as an executable application or set of instructions that is executed within the procedural software framework of the widget-container 105. The results of the executable application can be included and/or displayed within the procedural software framework of the widget-container 105. The widget-container 105 can be configured so that the widget 102 can be processed in a portion associated with the widget-container 105 in response to the widget-container 105 being received at a content aggregation point. More details regarding widget-containers and widgets are set forth in the above-identified co-pending application entitled, “Method and Apparatus for Widget-Container Hosting and Generation,” which is incorporated herein by reference in its entirety.

The content aggregation points 152, 162, and/or 172 can be configured such that only content, such as widget-container 105 and/or widget 102, that satisfies or substantially satisfies the content rules can be referenced, requested, and/or executed (e.g., displayed) within the content aggregation points 152, 162, and/or 172. The content rules can be administered and/or defined by an administrator or owner of one or more of the content aggregation points 152, 162, and/or 172. In some embodiments, a content rule can be based on a complex set of rules defined within an algorithm and/or a file that can be accessed from, for example, a server (not shown) associated with one or more of the content aggregation points 152, 162, and/or 172.

Each of the processing devices 150, 160, and/or 170 (also can be referred to as a widget-container processing device) can be any type of device that is configured to process any portion associated with the widget-container 105. Each of the processing devices 150, 160 and/or 170 can be, for example, a computer, a mobile phone, a personal digital assistant (PDA), a server, and/or any other processor-based device. The widget-container 105 can be configured and/or modified using the transform module 108 so that any portion associated with the widget-container 105 can be processed by each of the processing devices 150, 160, and/or 170 even though the platforms (e.g., hardware, architecture, software, operating system, runtime libraries, programming languages) of the respective processing devices 150, 160, and/or 170 may be different. The network 120 can be any type of network such as a local area network (LAN) and/or a wide area network (WAN) implemented as a wired and/or wireless network with one or more segments in a variety of environments such as, for example, an office complex.

The widget-container host 100 can be configured to use the transform module 108 to modify a portion associated with the widget-container 105 from a first configuration to a second configuration to satisfy one or more content rules such that the portion associated with the widget-container 105 can be associated with (e.g., referenced in) and/or executed within the content aggregation points 152, 162, and/or 172. The widget-container host 100 can be configured to modify the portion associated with the widget-container 105 to satisfy the content rule(s) associated with the content aggregation points 152, 162, and/or 172 such that the widget-container host 100 can send (e.g., serve, serve an instance of) the portion associated with the widget-container 105 to the content aggregation points 152, 162, and/or 172 when requested. In other words, the portion associated with the widget-container 105 can be modified by the widget-container host 100 before the portion associated with the widget-container 105 is referenced within, sent (e.g., served) to, and/or requested for execution at one or more of the content aggregation points 152, 162, and/or 172.

For example, assuming that widget-container 105 satisfies the content rules associated with content aggregation point 162, an instance of the widget-container 105 can be sent to content aggregation point 162 in response to a request for the instance of the widget-container 105 when a reference to the widget-container 105 is accessed from content aggregation point 162. The request for the widget-container 105 can be defined by processing device 160. In response to the request, the instance of the widget-container 105 can be sent from the widget-container host 100 to processing device 160 for execution within content aggregation point 162.

In some embodiments, a portion associated with the widget-container 105 (e.g., instances of the widget 102 and/or widget-container 105) can be served simultaneously and/or at different times to the content aggregation points 152, 162, and/or 172. Similarly, the content aggregation points 152, 162, and/or 172 (e.g., instances of the content aggregation points 152, 162, and/or 172) can be, for example, retrieved and/or processed at one or more of the processing devices 150, 160, and/or 170 simultaneously or at different times.

Although the widget 102 and widget-container 105 are illustrated in FIG. 1 as being sent from the widget-container host 100, in some embodiments, modified and/or unmodified portions of the widget-container 105 can be served from different devices. For example, an instance of the widget-container 105 can be dynamically generated to include a reference to the widget 102 at a first device. After the instance of the widget-container 105 is sent from the first device to, for example, content aggregation point 152 and begins executing within content aggregation point 152, the widget 102 can be requested based on the reference to the widget 102 and served from a second device for processing within the widget-container 105.

Each of the content aggregation points 152, 162, and/or 172 can be associated with one or more content rules that can be different. For example, the content rule(s) associated with the content aggregation point 152 can be different than the content rule(s) associated with the content aggregation point 162. The content rules can be, for example, a code rule, a metadata rule, a packaging rule, a format rule, and/or a rule related to a submission process. The content rules are categorized below, in part, to simplify the discussion. In other words, the content rules can be classified using different categories.

Although the transform module 108 is depicted as a module within the widget-container host 100, in some embodiments, the transform module 108 can be associated with a different device (not shown). In some embodiments, for example, the widget-container host 100 can be configured to cooperate (e.g., send and/or receive the widget-container 105 to and/or from) with a separate device that is configured to execute the transform module 108. The functionality of the transform module 108 can be separated into different modules that can also be executed at one or more devices.

In some embodiments, a widget 102 that is not associated with a widget-container can be modified according to a content rule associated with a content aggregation point such as content aggregation points 152, 162, and/or 172. The widget 102 can be modified using a transform module such as transform module 108 at, for example, a widget server (not shown) and/or at the widget-container host 100. In some embodiments, a reference to the widget 102 can be placed in (e.g., included in) one or more content aggregation points such as, for example, content aggregation point 162.

A code rule, for example, can be configured to require that the widget 102 be associated with or include a certain portion of processor-related code or processor-related instruction. The code rule may require that the processor-related code or processor-related instruction be integrated into or associated with the widget 102 and/or widget-container 105 in a particular way. In some embodiments, a code rule can be configured to require that the widget 102 be based on a certain type of programming language or have a certain programming language structure or sequence.

A metadata rule, for example, can be configured to require that specified metadata parameter values be associated with the widget 102 and/or widget-container 105 (e.g., content type metadata parameter value, screen shot) or that metadata values be represented in a particular format or according to a specified style. In some embodiments, a metadata rule can be configured to require association between certain types of metadata parameter values. More details regarding metadata parameter values as related to a widget-container are set forth in co-pending application Ser. No. 11/537,375, “Method and Apparatus for Widget Container/Widget Tracking and Metadata Manipulation,” which is incorporated herein by reference in its entirety.

A format rule, for example, can be configured to require that the widget 102 and/or widget-container 105 be smaller or larger than a specified dimension or specified byte size (e.g., <1 gigabyte). In some embodiments, a format rule can be configured, for example, to require that metadata parameter values have a particular format (e.g., dates in DD/MM/YYYY format) or specified font style.

A packaging rule, for example, can be configured to require that the widget 102 and/or widget-container 105 be compressed (e.g., zipped) or included in an specified type of framework (e.g., extensible markup language (XML) framework).

A submission process is a process for submitting the widget 102 and/or widget-container 105 for inclusion in any of the content aggregation points 152, 162, and 172. The submission process can include one or more steps defined in a content rule related to the submission process. The submission process can include steps that require intervention by an entity associated with the content aggregation points 152, 162, and 172, such as a computer, a server (e.g., back-end server, network server), or an administrative person. For example, content aggregation point 152 can, according to a content rule, require that the widget 102 and/or widget-container 105 be approved before a reference to the widget 102 and/or widget-container 105 can be included in the content aggregation point 152. The approval, for example, can be contingent on the widget 102 and/or widget-container 105 satisfying all of the specification rules associated with content aggregation point 152. In some embodiments, the widget-container host 100 can be configured to automatically send and/or receive notifications and/or indicators associated with a submission process.

A service module (not shown), if contained in the widget-container 105, can be associated with the widget 102. The service module (or reference to the service module) contained in the widget-container 105 can be a pre-defined and/or customizable (e.g., user-defined) function related to a variety of functions (e.g., tracking, placing) related to the widget-container and/or its components (e.g., widget). The service module can be modified to comply with one or more content rules. More details regarding service modules are set forth in the above-identified co-pending application entitled, “Method and Apparatus for Widget-Container Hosting and Generation.”

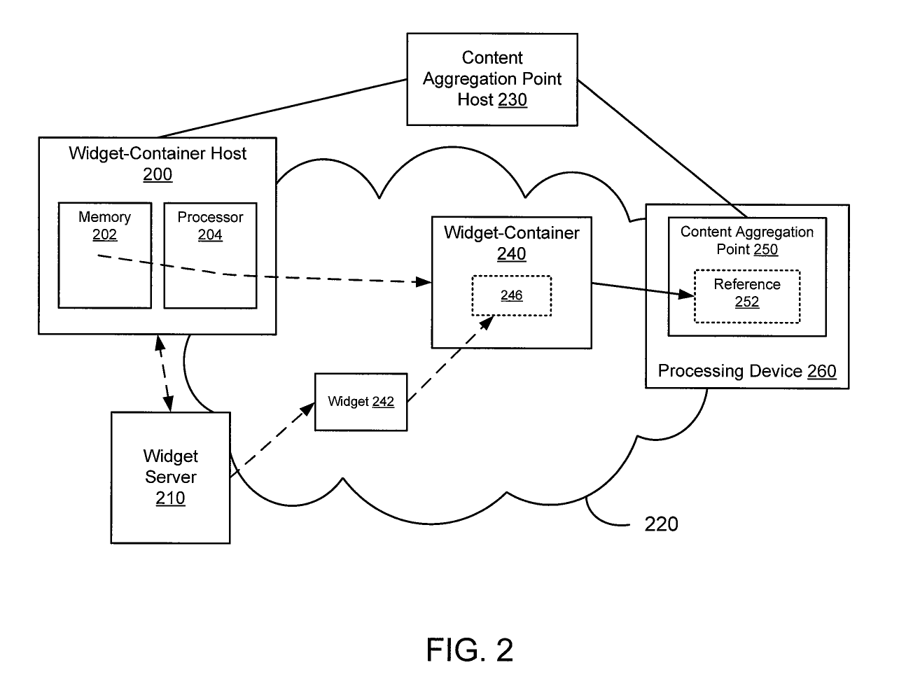

FIG. 2 illustrates a widget-container host 200 and widget server 210 configured to serve a widget-container 240 (e.g., serve an instance of the widget-container 240) and a widget 242 (e.g., serve an instance of the widget), respectively, to a content aggregation point 250, according to an embodiment of the invention. The widget-container 240 and the widget 242 can be modified according to content rules associated with the content aggregation point 250 such that the reference 252 to the widget-container 240 can be placed in the content aggregation point 250.

A processing device 260 is configured to display/execute the content aggregation point 250 and request the widget-container 240 (and widget 242) based on a reference 252 to the widget-container 240. The request can be defined by the processing device 260 when the reference 252 is accessed from the content aggregation point 250. In some embodiments, the widget 242 can be requested for processing within the widget-container 240 after at least a portion associated with the widget-container 240 is received and executed within the content aggregation point 250.

The widget-container host 200 can be configured to receive one or more content rules associated with the content aggregation point 250 via a content aggregation point host 230. The content aggregation host 230 can be configured to serve the content aggregation point 250 to the processing device 240 in response to a request for the content aggregation point 250 defined by the processing device 260. The content aggregation point host 230 can be configured to store one or more versions of content rules associated with multiple content aggregation points (not shown).

The content aggregation point host 230 can be configured to send one or more content aggregation rules to the widget-container host 200 in response to a request from the widget-container host 200. The widget-container host 200 can be configured to store one or more content rules in the memory 202 or a separate database (not shown) where the content rules can be accessed by the widget-container host 200. In some embodiments, the content aggregation point host 230 can be configured to send content rules to the widget-container host 200 periodically (e.g., nightly) or randomly. In some embodiments, the content aggregation point host 230 can be configured to send an updated content rule to the widget-container host 200 when a content rule is, for example, changed. An updated content rule can be referred to as a different or new version of a content rule. The content aggregation point host 230 can be configured to send the updated portion of the content rule or the entire updated content rule (e.g., new version of the content rule, different version of the content rule). The content rule can be updated by, for example, an administrator associated with the content aggregation point 250 and/or automatically by, for example, a processor. In some embodiments, the widget-container host 200 can be configured to receive a content rule from a source (not shown) other than the content aggregation point host 230.

As shown in FIG. 2, the widget-container 240 is served from a memory 202 of the widget-container host 200. The widget-container host 200 can modify, if necessary, the widget-container 240 based on one or more content rules received from the content aggregation host 230. For example, the widget-container host 200 can modify a metadata parameter value and/or a portion of programming code associated with the widget-container host 200 based a content rule associated with the content aggregation point 250. In some embodiments, the widget-container host 200 can request a content rule and/or updated content rule before modifying the widget-container 200 from a first configuration to a second configuration. For example, the widget-container host 200 can be configured to retrieve and/or request the content rule in response to a request to serve the widget-container 240 to the processing device 260 for display/execution within the content aggregation point 250. In other words, the widget-container host 200 can be configured to retrieve the content rule only when necessary.

In some embodiments, the widget-container host 200 can be configured to modify the widget-container 240 from a first configuration to a second configuration according to a content rule associated with the content aggregation point 250 and store the modified widget-container 240 in the memory 202 or a separate database (not shown). When a request for the widget-container 240 is received at the widget-container host 200 from, for example, the processing device 260, the widget-container host can retrieve the widget-container 240 from the memory 202 or the separate database and serve the widget-container 240 (e.g., serve an instance of the widget-container 240) to the processing device 260.

In some embodiments, the widget-container host 200 can be triggered to determine whether the widget-container 240 should be modified and/or updated based on an updated content rule. For example, the widget-container host 200 can determine whether an updated content rule has been defined since the widget-container 240 was last modified based on, for example, a timestamp associated with the widget-container 240. If the widget-container 240 was last updated longer than a threshold period of time, for example, the widget-container host 200 can query the content aggregation point host 230 to determine whether an updated content rule exists (e.g., has been released or defined since the widget-container 240 was last modified).

Also, as shown in FIG. 2, the widget 242 can be served from the widget server 210 for processing within the widget-container 240 at the processing device 260. In some embodiments, the widget 242 can be served for processing at the processing device 260 after the widget-container 240 has been received at the processing device 260. For example, the widget 242 can be served in response to a request from the processing device 260 based on a reference 246 to the widget 242 included in the widget-container 240.

The widget server 210 and/or the widget-container host 200 can be configured such that the widget 242 is sent to the widget-container host 200 to be modified based on one or more content rules associated with the content aggregation point 250 and returned to the widget server 210 to be served from the widget server 210 when requested. In some embodiments, the widget server 210 can be configured to send the widget 242 to the widget-container host 200 for modification based on one or more content rules in response to the widget-container 240 being defined. After the widget 242 has been modified, the widget 242 can be sent from the widget-container host 200 to the widget server 210 and stored at the widget server 210. An instance of the widget 242 can be served to the processing device 260 in response to a request (e.g., a request after the widget-container 240 has been served).

The reference 246 to the widget 242 included within the widget-container 240 can be defined to reference the location from which the widget 242 will be served. In some embodiments, the reference 246 can be dynamically defined, for example, based on a metadata parameter value when the widget-container 240 is, for example, dynamically generated. More details related to dynamic widget-container generation are set forth in the above-identified co-pending application entitled, “Method and Apparatus for Widget-Container Hosting and Generation.”

The widget-container host 200 can be configured to send an indicator to the widget server 210 to indicate that an updated content rule associated with the widget 242 has been received and/or defined. The widget server 210 can respond by sending the widget 242 to the widget-container server 210 for modification based on the updated content rule. The widget server 210 can be configured to receive the modified widget 242 and serve the modified widget 242.

In some embodiments, the widget server 210 can be configured to query the widget-container host 200 regarding updates to content rules. The widget-container host 200 can be configured to respond to these queries and can request that the widget 242 be sent from the widget server 210 such that the widget 242 can be modified at the widget-container host 200. In some embodiments, the widget server 210 can be configured to query the widget-container host 200 before serving an instance of the widget 242. The widget server 210 can also be configured to query the widget-container host 200 to determine whether an updated content rule exists based on a criteria (e.g., widget 242 last modified more than a threshold period of time).

In some embodiments, a modification of the widget-container 240 and/or a modification of the widget 242 can be based on one or more shared content rules. In some embodiments, the widget-container 240 can be modified based on and/or associated with one or more content rules that are not associated with the widget 242 even though the widget 242 is referenced in and associated with the widget-container 240.

Although only one widget-container 240 and one widget 242 are shown in FIG. 2, in some embodiments, the widget server 210 and/or widget-container host 200 can be configured to store and/or serve multiple widgets (not shown) and/or widget-containers (not shown), respectively, to multiple content aggregation points (not shown). For example, multiple instances of the widget-container 240 and/or widget 242 can be served to multiple content aggregation points synchronously and/or asynchronously. In some embodiments, multiple widget servers (not shown) can be associated with a single widget-container host, such as widget-container host 200, and vice versa.

In some embodiments, a cached copy of the widget 242 and/or widget-container 240 (e.g., any portion associated with the widget-container 240) can be stored at the content aggregation point host 230 for serving to the content aggregation point 250. The cached copy of the widget 242 and/or widget-container 240 can be produced at the widget-container host 200. The cached copy of the widget 242 and/or widget-container 240 can be based on content rule(s) associated with the content aggregation point 250. If an updated version of the content rule(s) is detected and/or associated with the content aggregation point 250, the widget-container host 200, in cooperation with the widget server 210, can be configured to replace the cached copy of the widget 242 and/or widget-container 240 with a modified widget 242 and/or the widget-container 240, respectively, based on the updated version of the content rule(s).

In some embodiments, an instance of the widget 242 and/or widget-container 240 can be submitted according to a submission process (e.g., submission process content rule) for caching at the content aggregation point host 230. The widget-container host 200 can be configured to follow the submission process defined with, for example, a content rule. In some embodiments, the widget-container host 200 can send a notification to an entity in response to the submission process being completed. For example, the widget-container host 200 can be configured to send a notification to an entity that requested that the widget 242 and/or widget-container 240 be included in the content aggregation point 250.

In some embodiments, rather than sending a modified widget 242 to the widget server 210 for serving, the widget-container host 200 can be configured to store the modified widget 242 and serve the modified widget 242 from the widget-container host 200 to the content aggregation point 240.

In some embodiments, a widget 242 that is not associated with a widget-container can be modified according to a content rule associated with a content aggregation point, such as content aggregation point 250. The widget 242 that is not associated with a widget-container can be modified at and/or served from, for example, the widget server 210 and/or at the widget-container host 200. The widget 242 can be served, for example, in response to a reference (not shown) to the widget 242 being accessed from the content aggregation point 250.

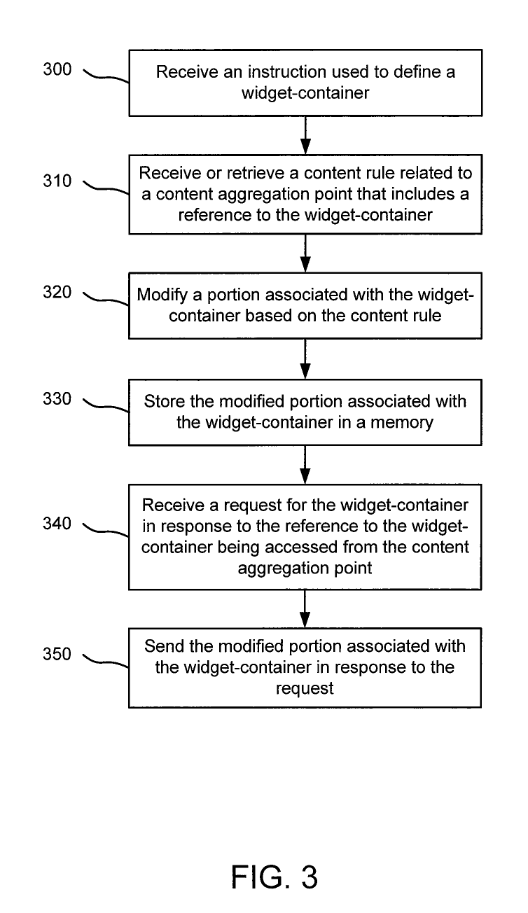

FIG. 3 is a flowchart that illustrates a method for modifying a portion associated with a widget-container based on a content rule associated with a content aggregation point, according to an embodiment of the invention. The flowchart illustrates that an instruction defining a widget-container associated with a widget is received at 300. The instruction can be used to dynamically produce (e.g., generate) the widget-container when a request for the widget-container is received.

A content rule related to a content aggregation point that includes a reference to the widget-container is received or retrieved at 310. In some embodiments, the content rule can be received or retrieved from, for example, a content aggregation point host. The content rule can be received at a widget-container host in response to a request for the content rule from the widget-container host. The content rule can be stored in a database and associated with, for example, a customizable parameter values (e.g., metadata parameter values) associated with the widget-container.

A portion associated with the widget-container is modified based on the content rule at 320. For example, a format of a metadata parameter value associated with a widget that is referenced within the widget-container can be modified based on the content rule. The portion associated with the widget-container can be modified using a transform module at a widget-container host.

After the portion associated with the widget-container has been modified, the modified portion associated with the widget-container can be stored in a memory at 330. The modified portion associated with the widget-container can be stored at, for example, a widget-container host and/or a widget server.

A request for the widget-container can be received in response to the reference to the widget-container being accessed from the content aggregation point at 340. The request can be defined by a processing device that accesses the reference while displaying/executing the content aggregation point. The request can be sent to, for example, a content aggregation point host if the content aggregation point host is storing a cached copy of a modified or unmodified portion associated with the widget-container.

The modified portion associated with the widget-container is then sent in response to the request at 350. For example, if the widget-container is the portion to be modified, the instruction used to define the widget-container can be modified and used to dynamically generate a modified widget-container. The modified widget-container can then be sent in response to the request. If the widget-container is the portion to be modified and the widget-container is stored in the memory as a static widget-container, the widget-container can be modified and the modified widget-container can be sent in response to the request. In some embodiments, the widget and/or service module can be the portion associated with the widget-container that is modified and sent.

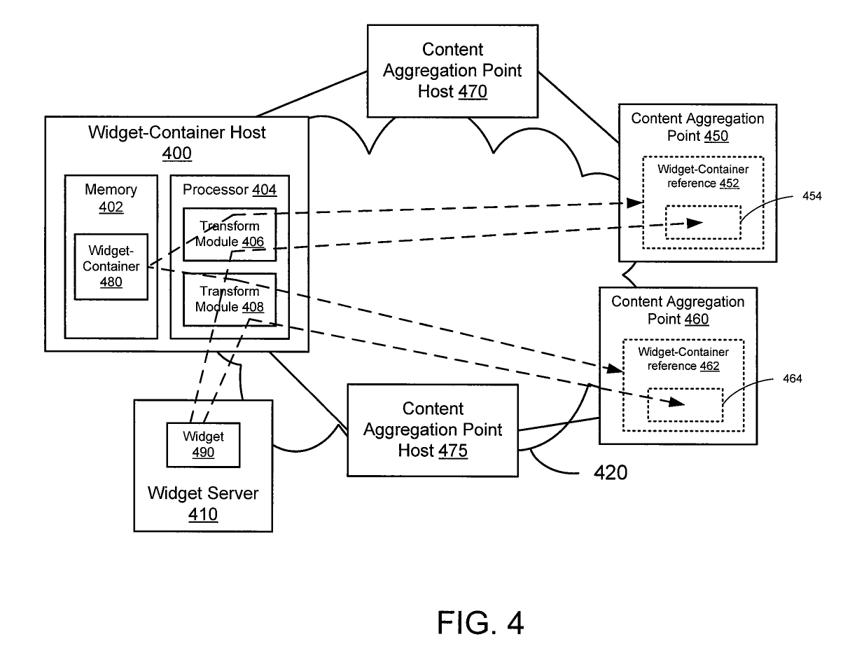

Because each of several content aggregation points can be associated with one or more different content rules, a portion associated with a widget-container can be modified based on different content rules that correspond with each of the content aggregation points. FIG. 4 illustrates a widget server 410 configured to send a widget 490 (e.g., an instance of the widget 490) and a widget-container 480 (e.g., an instance of the widget-container 480) to a widget-container host 400 to be modified at the widget-container host 400 before being sent to content aggregation point 450 and/or content aggregation point 460, according to an embodiment of the invention. In this embodiment, each of the content aggregation points 450 and 460 are associated with a different set of content rules. The content aggregation points 450 and 460 can be associated with, for example, a mobile phone or personal computer. In some embodiments, the set can be a set of one content rule. In some embodiments, the set of content rules associated with each of the content aggregation points 450 and 460 can be similar and/or overlapping. In some embodiments, the set of content rules associated with each of the content aggregation points 450 and 460 can be the same. Although not shown, the content aggregation points 450 and 460 can be executed within processing devices (e.g., cell phone, computer) that can be the same or different types of devices based on different platforms (e.g., WAP v. hyper-text mark-up language (html)).

Because the content rules for each of the content aggregation points 450 and 460 can be different, the widget 490 and/or widget-container 480 can be modified using transform modules 406 and 408 that correspond, respectively, with the content aggregation points 450 and 460. For example, when the widget 490 and/or widget-container 480 are served over network 420 to content aggregation point 450, an instance of widget 490 and/or widget-container 480 are modified using a transform module 406 that corresponds with content aggregation point 450. The transform module 406 can be a module defined to modify the widget 490 from a first configuration to a second configuration according to one or more content rules associated with content aggregation point 450. Likewise, when the widget 490 and/or widget-container 480 are served over network 420 to content aggregation point 460, an instance of widget 490 and/or widget-container 480 can be modified using a transform module 408 that corresponds with content aggregation point 450. The transform module 408 can be a module defined to modify the widget 490 according to one or more content rules associated with content aggregation point 460.

The transform modules 406 and 408 can be software modules and/or hardware modules that can be executed on processor 404 and/or integrated into processor 404. In some embodiments, the functionality associated with each of the transform modules 406 and 408 can be integrated into a single transform module (not shown) or multiple transform modules (not shown). In some embodiments, the transform module 406 and 408 can be hard-coded transform modules or dynamically generated transform modules.

In some embodiments, the transform modules 406 and 408 can be configured to dynamically receive one or more parameter values associated with a content rule(s) from the content aggregation point hosts 470 and 475, respectively. For example, transform module 406 can be configured to receive an updated (e.g., new version) content rule and/or an updated parameter value associated with a content rule (e.g., updated content rule parameter value) from content aggregation point host 470 and modify the widget 490 from a first configuration to a second configuration based on the updated content rule. The transform module 406 can be configured to receive updates from content aggregation point host 470 based on the association of the transform module 406 and the content aggregation point host 470 with content aggregation point 450. Updates associated with content rules can be received at the widget-container host 400 from the content aggregation point hosts 470 and 475, for example, in response to a request for a portion associated with a widget-container, periodically, in response to a change in a content rule, and/or based on a threshold criteria associated with a portion associated with a widget-container.

Instances of the widget-containers 480 are configured to process the widget 490 at the content aggregation points 450 and 460. Sending of the widget-container 480 (e.g., an instance of the widget-container 480) for execution at the content aggregation points 450 and 460 can be triggered in response to the widget-container references 452 and 462, respectively, being accessed from the content aggregation points 450 and 460. Sending of the widget 490 (e.g., an instance of the widget 490) for processing within the widget-container 480 can be triggered in response to the widget-references 454 and 464, respectively, being accessed from the widget-containers 452 and 462.

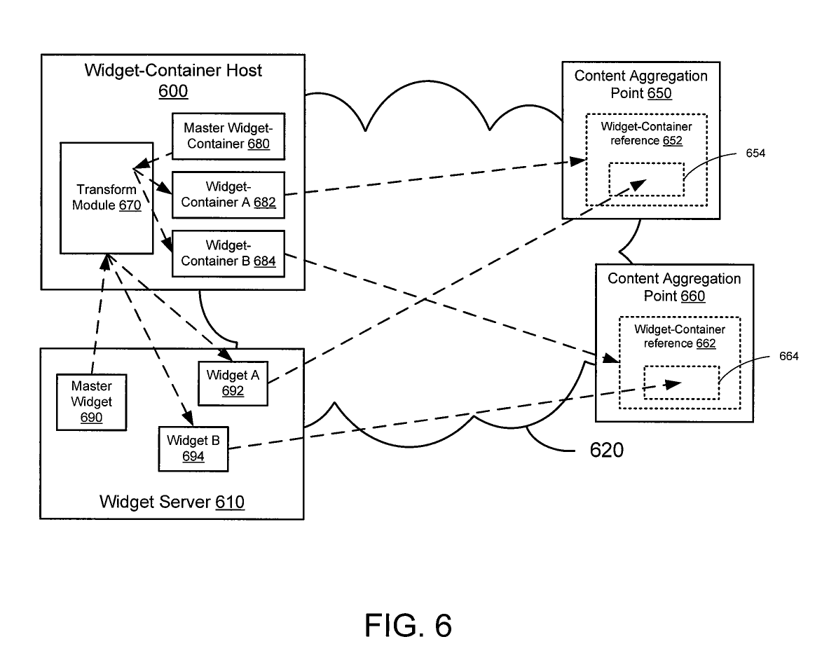

Although the widget references 454 and 464 are depicted as being disposed within the widget-container references 452 and 462, respectively, this depiction is to simplify FIG. 4. The widget references 454 and 464 are references included in instances of the widget-container 480 and can be accessed in response to an instance of the widget-container 480 being executed at, for example, content aggregation point 450. The widget-container references 452 and 462 are depicted as being disposed within the widget-container references 452 and 462, respectively, to illustrate their relationship with the widget-container 480 and their relationship with the content aggregation points 450 and 460, respectively. Note that a similar depiction is included in FIG. 6.

An instance of the widget 490, for example, can be requested for processing within an instance of widget-container 480 based on a widget request defined in response to the widget-reference 454 being accessed. The widget request can be subsequently sent to the widget-container host 400. In response to the widget request, the widget-container host 400 can receive an instance of the widget 490 from the widget server 410 and modify the instance of the widget 490 using transform module 406 before sending the modified instance of the widget 490 for processing within the instance of widget-container 480. In some embodiments, the widget-container host 400 can request an instance of the widget 490 from the widget server 410. In some embodiments, the widget server 410 can be configured to detect the widget request and send an instance of the widget 490 to the widget-container host 400 such that the instance of the widget 490 can be modified using the transform module 406.

The widget-container host 400 can be configured to determine which of the transform modules 406 and 408 to use to modify the widget 490 and/or the widget-container 480 from a first configuration to a second configuration. In some embodiments, the widget-container host 400 can be configured to select one of the transform modules 406 or 408 based on one or more parameters/identifiers included in the request for the widget 490 and/or the widget-container 480.

For example, a placement identifier that uniquely indicates that an instance of the widget-container 480 is associated with content aggregation point 450 can be extracted from, for example, the reference to the widget-container 452 and/or widget reference 454. The placement identifier can be included in the request for widget 490 and used to determine that transform module 406 is the proper transform module for modifying an instance of the widget 490 to satisfy the request for processing within the content aggregation point 450. The determination can be based on, for example, data within a database that associates transform modules with placement identifiers, and thus, with content aggregation points.

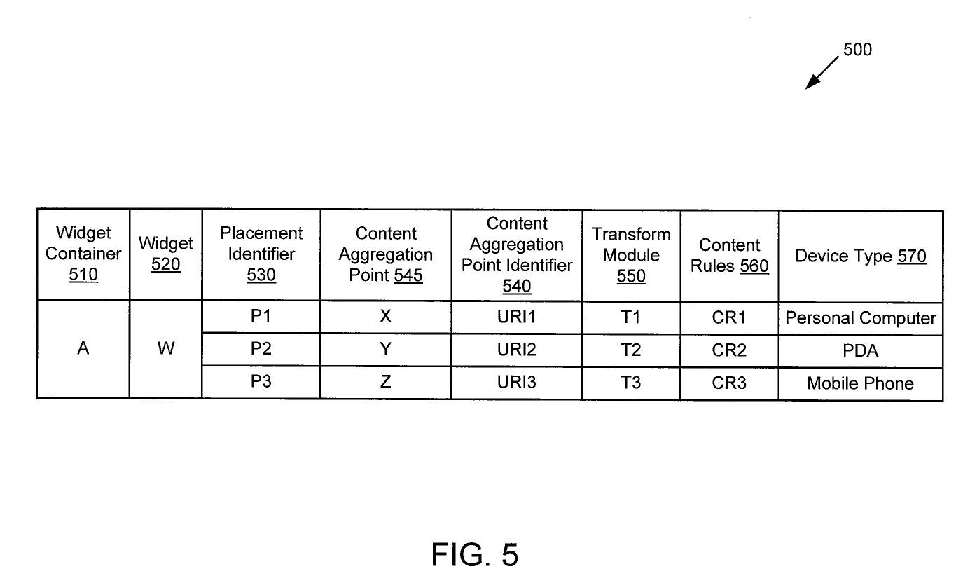

FIG. 5 illustrates an example of a table 500 that can be used to select a transform module 550 to modify a portion associated with a widget-container 510 for processing at a content aggregation point 545, according to an embodiment of the invention. The table 500 illustrates that the content rules CR1, CR2, and CR3 (column 560) correspond with content aggregation points X, Y, and Z, respectively, shown in column 545. The table 500 also illustrates that transform modules T1, T2, and T3 (column 550) can be used to transform widget-container A (column 510) and/or widget W (column 520) according to the content rules CR1, CR2, and CR3, respectively. For example, based on an indicator of the content aggregation point identifier 540 (e.g., uniform resource identifier (URI)) received in, for example, a request for widget-container A, table 500 can be used to determine that transform module T1 can be used to modify an instance of widget W for processing in content aggregation point X at a personal computer. Also, based on an indicator of the content aggregation point identifier 540 (e.g., uniform resource identifier (URI)) received in, for example, a request for widget-container A, table 500 can be used to determine that transform module T3 can be used to modify an instance of widget W for processing in content aggregation point Z at a mobile phone.

The identifier of the content aggregation point 540 can be received at, for example, a widget-container host for use in selecting a transform module at the widget-container host. A request for the widget-container 510, for example, can include the identifier of the content aggregation point 540 or a separate identifier such as a placement identifier 530 that can be used to look-up the identifier of the content aggregation point 540. In some embodiments, the identifier of the content aggregation point 540 can be retrieved from a metadata database (not shown) that can be used to associate a widget-container reference with the identifier of the content aggregation point 540.

Although, a transform module 550 can be selected based on one or more content aggregation point identifiers 540, in some embodiments, a transform module 550 can be selected based on a variety of parameters that can be, for example, stored in a metadata parameter database. For example, a transform module 550 can be selected based on parentage information in a metadata database (not shown) or a placement identifier 530 associated with a particular placement of a reference to a widget-container 510 in a content aggregation point 545 associated with the content aggregation point identifiers 540.

For example, in some embodiments, the placement identifier 530 can be included in a reference to a widget-container 510 placed in a content aggregation point 545 and can be used in selecting a transform module 550. When a reference to widget-container A is accessed from a content aggregation point 545, a request for widget-container A can be defined to indicate the placement identifier 530 uniquely associated with the particular placement of widget-container A and included in the reference. If the instance of widget-container A being requested is the widget-container placed in the content aggregation point X, the request can include the placement identifier P1 from the reference. The placement identifier P1 can then be used to determine based on table 500 that a portion associated with the widget-container can be modified according content rules CR1 using transform module T1.

Referring back to FIG. 4, although not shown, the transform modules 406 and 408 can be configured to transform any portion associated with the widget-container 480 such as a service module (not shown) contained within the widget-container 480. The service module can be served from a service module server (not shown). The transform modules 406 and/or 408 can be used to modify any portion associated with the widget-container 480 from a first configuration to a second configuration for compatibility with a platform associated with processing devices used to execute the content aggregation points 450 and/or 460. The widget-container host 400 can be configured to detect the platform and use transform module 406 and/or 408 or a separate transform module.

In some embodiments, a transform module based on a set of platform rules that correspond with, for example, a processing device type can be used to modify any portion associated with the widget-container 480 for compatibility with the processing device type. For example, a first set of platform rules can be associated with a cell phone and a second set of platform rules can be associated with a personal computer.

Although the widget-container 480 originates at the memory 402 of the widget-container host 400 and the widget 490 originates at the widget server 410 as shown in FIG. 4, the widget 490 and/or widget-container 480 can be stored in different locations. For example, the widget 490 and/or widget-container 480 can be stored in the memory 402 and served from the widget-container host 400 after being modified at the processor 404.

In some embodiments, an instance of the widget 490 and/or widget-container 480 can be modified using, for example, transform module 406 and submitted according to a submission process (e.g., submission process content rule). In some embodiments, an instance of the widget 490 and/or widget-container 480 can be modified according to a submission process for caching at, for example, content aggregation point host 470. The cached copy of the modified instance of the widget 490 and/or widget-container 480 can be received from the content aggregation point host 470 and processed at, for example, content aggregation point 450 rather a modified instance of the widget 490 and/or widget-container 480 being received from the widget-container host 400 and/or widget server 410, respectively.

FIG. 6 illustrates a widget-container host 600 configured to produce instances of a master copy of a widget-container 680 (also can be referred to as master widget-container) and/or a master copy of a widget 690 (also can be referred to as master widget) using a transform module 670, according to an embodiment of the invention. The widget-container host 600 can be configured to produce, using the transform module 670, instances (e.g., static copies) of the master widget-container 680 and/or the master widget 690 that correspond with the content aggregation points 650 and/or 660. In other words, the widget-container host 600 can be configured to produce instances (e.g., static copies) of the master widget-container 680 and/or the master widget 690 that satisfy the content rules associated with each of the content aggregation points 650 and 660.

As shown in FIG. 6, the widget-container host 600 includes widget-container A 682, which is an instance of the master widget-container 680 modified according to content rules associated with content aggregation point 650, and widget-container B 684, which is an instance of the master widget-container 680 modified according to content rules associated with content aggregation point 660. Similarly, the widget server 610 includes widget A 692, which is an instance of the master widget 690 modified according to content rules associated with content aggregation point 650, and widget B 694, which is an instance of the master widget 690 modified according to content rules associated with content aggregation point 660.

The instances (e.g., copies) of the master copies of the widget-container 680 and the widget 690—widget-container A 682, widget-container B 684, widget A 692, widget B 694—can be served to the content aggregation points 650 and 660 in response to a request. For example, in response to a request defined based on widget-container reference 652 from content aggregation point 650, the widget-container host 600 can serve an instance of widget-container A 682 to the content aggregation point 650. Likewise, the widget server 610 can serve an instance of widget A 692 for processing within the content aggregation point 650 in response to a request defined based on widget reference 655.

In some embodiments, the instances (e.g., copies) of the master copies of the widget-container 680 and the widget 690—widget-container A 682, widget-container B 684, widget A 692, widget B 694—can be modified and/or updated based on content rule updates. For example, the integrity of the master copy of the widget 690 can be maintained (e.g., not modified) even when updating widget A 692 and widget B 694.

Although in this embodiment the instances of the master copy of the widget 690, widget A 692 and widget B 694, are sent to the widget server 610 for serving to the content aggregation points 650 and 660, in some embodiments, the instances of the master copy of the widget 690 can be stored at and served over network 620 from the widget-container host 600.

In some embodiments, the instances (e.g., copies) of the master copies of the widget-container 680 and the widget 690—widget-container A 682, widget-container B 684, widget A 692, widget B 694—can be created based on a user-defined request.

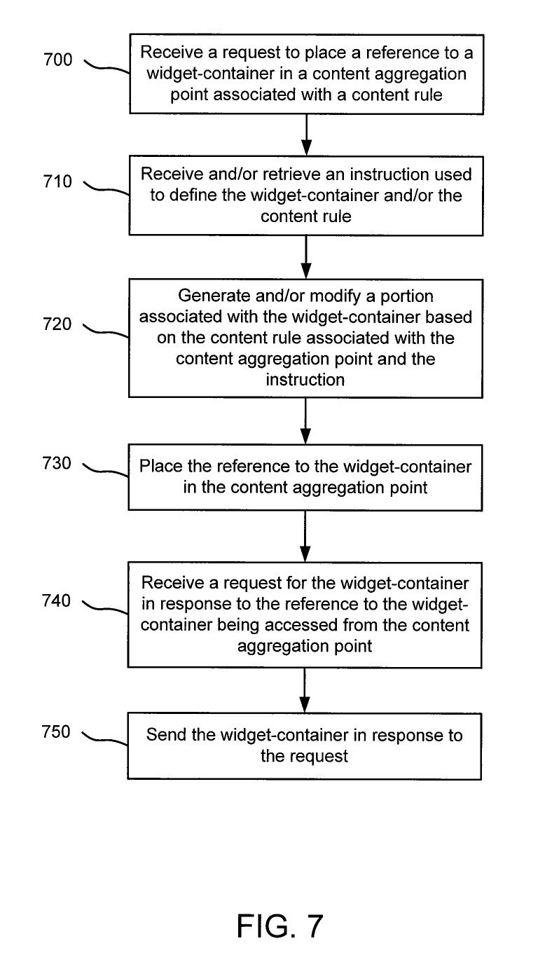

FIG. 7 is a flow chart that illustrates a method for placing a reference to a widget-container in a content aggregation point, according to an embodiment of the invention. The flowchart illustrates that a request to place a reference to a widget-container in a content aggregation point associated with a content rule is received at 700. The request can be a user-defined request based on a set of possible content aggregation points (e.g., menu of content aggregation points) where a widget-container can be placed. The set of possible content aggregation points can be defined based on the capability of, for example, a widget-container host to modify a portion associated with a widget-container using one or more transform modules.

An instruction used to define the widget-container and/or the content rule is received and/or retrieved at 710. The instruction can be received at, for example, a widget-container host configured to produce a widget-container based on the instruction and based on a content rule. In some embodiments, a widget-container host can be configured to retrieve the instruction in response to a request to place the reference of the widget-container in the content aggregation point.

A portion associated with the widget-container is generated and/or modified based on the content rule associated with the content aggregation point and/or the instruction at 720. For example, the portion associated with the widget-container (e.g., widget, service module, widget-container, entire widget-container including the widget and/or service module) can be generated (e.g., produced, dynamically generated) at a widget-container host using a widget-container generation engine. In some embodiments, the portion associated with the widget-container can be modified based on the content rule using, for example, a transform module defined based on the content rule. In some embodiments, the instruction used to generate the portion associated with the widget-container can be modified based on the content rule using, for example, a transform module defined based on the content rule. The modified instruction can be used to generate (e.g., dynamically generate) the portion associated with the widget-container. In some embodiments, a widget associated with a widget-container is modified and not generated.

In some embodiments, the widget-container can contain references to a widget and/or service module. The widget-container, widget, and/or service module can be modified based on one or more content rules associated with the content aggregation point.

After the portion associated with the widget-container is modified and/or generated according to the content rule, the reference to the widget-container in the content aggregation point is placed at 730. The reference can be placed in the content aggregation point by, for example, a content aggregation point host in response to an indicator from, for example, a widget-container host indicating that the widget-container is compliant (e.g., substantially compliant) with the content rules associated with the content aggregation point. In some embodiments, the reference to the widget-container is placed by a content aggregation point host after the content aggregation point host assesses the widget-container and determines that the widget-container complies with one or more content rules associated with the content aggregation point.

After the reference to the widget-container has been placed, a request for the widget-container is received in response to the reference to the widget-container being accessed from the content aggregation point at 740. The widget-container is sent in response to the request at 750. The widget, service-module, and/or widget-container (which are compliant with one or more content rules associated with the content aggregation point) can be sent to the content aggregation point from one or more devices. For example, the widget-container can be sent from a widget-container host and the widget can be sent from a widget server.

Some embodiments of the invention relate to a storage product with a processor-readable medium having instructions (e.g., instructions within a module) or code thereon for performing various processor-implemented operations. The media and code may be those specially designed and constructed for the purposes of the invention, or they may be of the kind well known and available to those having skill in the software arts. Examples of processor-readable media include, but are not limited to: magnetic storage media such as hard disks, floppy disks, and magnetic tape; optical storage media such as Compact Disc/Digital Video Discs (“CD/DVDs”), Compact Disc-Read Only Memories (“CD-ROMs”), and holographic devices; magneto-optical storage media such as floppy or optical disks; carrier wave signals; and hardware devices that are specially configured to store and execute program code, such as Application-Specific Integrated Circuits (“ASICs”), Programmable Logic Devices (“PLDs”), and ROM and RAM devices. Examples of code include, but are not limited to, micro-code or micro-instructions, machine instructions, such as produced by a compiler, and files containing higher-level instructions that are executed by a processor using an interpreter. For example, an embodiment of the invention may be implemented using Java, C++, or other object-oriented programming language and development tools. Additional examples of code include, but are not limited to, control signals, encrypted code, and compressed code.

In conclusion, the present invention is related to an apparatus and methods translation of content and/or data associated with the content for compatibility with content aggregation points. Those skilled in the art can readily recognize that numerous variations and substitutions may be made in the invention, its use and its configuration to achieve substantially the same results as achieved by the embodiments described herein. Many variations, modifications and alternative constructions fall within the scope and spirit of the disclosed invention as expressed in the claims.

What is claimed is:

1. A method, comprising:
receiving a request for a widget-container, the request being produced in response to a reference to the widget-container being accessed from a content aggregation point, the widget-container being a procedural software framework configured to be executed within the content aggregation point at a processing device, the widget-container having a portion configured for receiving a widget; and
modifying the widget, the widget being based on a first configuration before the modifying and based on a second configuration substantially compliant with a content rule associated with the content aggregation point after the modifying.

2. The method of claim 1, further comprising:
receiving the content rule based on an identifier associated with the content aggregation point, the modifying includes modifying based on the content rule, the first configuration of the widget being non-compliant with the content rule.

3. The method of claim 1, further comprising:
receiving an indicator that the reference to the widget-container has been placed in the content aggregation point; and
retrieving, in response to the receiving of the indicator, the content rule based on an identifier associated with the content aggregation point, the modifying includes modifying before the receiving the request.

4. The method of claim 1, wherein the modifying includes modifying in response to the request for the widget-container.

5. The method of claim 1, further comprising:
generating at least a portion of the widget-container in response to the request;
sending the widget-container to the processing device in response to the request; and
sending the widget based on the second configuration, the sending includes sending to a device configured to serve the widget based on the second configuration to the processing device, the widget being served after the widget-container has been received at the processing device.

6. The method of claim 1, further comprising:
receiving the widget based on the first configuration from a widget server;
sending, before the modifying, the widget-container to the processing device in response to the request; and
sending, after the modifying, the widget based on the second configuration to the processing device.

7. The method of claim 1, wherein the widget-container contains a service module,
the method further comprising:
generating at least a portion of the widget-container in response to the request, the service module being a pre-defined function associated with the widget-container before the widget-container is generated.

8. The method of claim 1, wherein the reference is uniquely defined to trigger sending of the widget-container for execution within a location of the first content aggregation point.

9. A method, comprising:
receiving a first widget, the first widget being at least one of a static data object, a media object, or a software object; and
producing, based on the first widget, a second widget and a third widget, the second widget being configured for processing within a first instance of a widget-container associated with a first content aggregation point, the third widget being configured for processing within a second instance of the widget-container associated with a second content aggregation point, the widget-container being a procedural software framework configured to be executed at a processing device.

10. The method of claim 9, wherein the first content aggregation point is executed on a first processing device type, the second content aggregation point is executed on a second processing device type, the producing includes producing the second widget based on a platform rule associated with the first processing device type.

11. The method of claim 9, wherein the second widget is based on a first configuration substantially compliant with a first content rule associated with the first content aggregation point, the third widget is based on a second configuration substantially compliant with a second content rule associated with the second content aggregation point.

12. The method of claim 9, wherein the widget-container contains a service module associated with the widget, the service module is a pre-defined function associated with the widget-container before the widget-container is generated.

13. The method of claim 9, further comprising:
receiving an identifier associated with the first content aggregation point, the producing includes producing the second widget using a transform module selected based on the identifier associated with the first content aggregation point.

14. The method of claim 9, wherein the receiving and the changing are performed at a first device,
the method further comprising:
sending the first instance of the widget-container to the processing device in response to a request for the first instance of the widget-container;
sending, after the producing, the second widget to a second device configured to receive a request for the second widget, the second device being configured to send the second widget to the processing device in response to a request for the second widget.

15. A method, comprising:
selecting a transform module based on an identifier associated with a content aggregation point, the content aggregation point including a reference to a widget-container having a portion configured to receive a widget, the widget-container being a procedural software framework configured to be executed at a processing device; and
modifying at least one of the widget or a service module using the transform module, the at least one of the widget or the service module being based on a first configuration before the modifying and based on a second configuration substantially compliant with a content rule associated with the content aggregation point after the modifying.

16. The method of claim 15, wherein the reference is a first reference, the first reference to the widget-container is uniquely defined to trigger sending of the widget-container for execution within a location of the first content aggregation point, the widget-container contains a second reference defined to trigger sending of the at least one of the widget or the service module based on the second configuration to the widget-container.

17. The method of claim 15, wherein the reference is a first reference,
the method further comprising:
generating the widget-container based on a configuration compatible with the content aggregation point, the generating includes generating the widget-container with a second reference defined to trigger sending the at least one of the widget or a service module for processing within the portion of the widget-container.

18. The method of claim 15, wherein the reference is a first reference, the content aggregation point is a first content aggregation point, the widget-container includes a placement service module configured for placing a second reference to the widget-container in a second content aggregation point.

19. The method of claim 15, wherein the widget-container contains a service module,
the method further comprising:
receiving a request for the widget-container from the processing device; and
generating, before the selecting, the widget-container in response to the request.

20. The method of claim 15, wherein the transform module is selected from a set of transform modules, each transform module from the set of transform modules is associated with at least one content aggregation point from a plurality of content aggregation points.

21. A method, comprising:
receiving a request for a widget-container defined in response to a reference to the widget-container being accessed from a content aggregation point, the widget-container being a procedural software framework configured to be executed within the content aggregation point, the widget-container having a portion configured for receiving a widget; and
modifying a portion of the widget-container, the portion of the widget-container being based on a first configuration before the modifying and based on a second configuration substantially compliant with a content rule associated with the content aggregation point after the modifying.

22. A method, comprising:
receiving a widget associated with a content aggregation point, the content aggregation point being configured to receive the widget in response to a reference to the widget being accessed from the content aggregation point; and
modifying a portion associated with the widget, the portion associated with the widget being based on a first configuration before the modifying and based on a second configuration substantially compliant with a content rule associated with the content aggregation point after the modifying.
